(19) United States
(12) Patent Application Publication
(10) Pub. No.: US 2018/0277274 A1
(43) Pub. Date: Sep. 27, 2018

(54) METHOD FOR DECONTAMINATING NICKEL-BASED ALLOY

(71) Applicants: KABUSHIKI KAISHA TOSHIBA, Minato-ku (JP); Toshiba Energy Systems & Solutions Corporation, Kawasaki-shi (JP)

(72) Inventors: Koji Negishi, Kawasaki (JP); Yumi Yaita, Ota (JP); Hiromi Aoi, Yokohama (JP); Miyuki Arai, Yokohama (JP)

(73) Assignees: KABUSHIKI KAISHA TOSHIBA, Minato-ku (JP); Toshiba Energy Systems & Solutions Corporation, Kawasaki-shi (JP)

(21) Appl. No.: 15/924,471

(22) Filed: Mar. 19, 2018

(30) Foreign Application Priority Data
Mar. 21, 2017 (JP) 2017-054882

(51) Int. Cl. G21F 9/00; B08B 3/08

(52) U.S. Cl. CPC G21F 9/004; G21F 9/005; G21Y 2004/504; G21Y 2002/501; G21Y 2004/20; B08B 3/08

(57) ABSTRACT

A method for decontaminating the nickel-based alloy includes oxidization of an oxide film accumulating radioactive nuclides with a first oxidizing agent to elute nickel into a solvent and thus to transform into a low-nickel film (S13 to S15). Elution amounts of Nickel, Chromium, and iron in the solvent are measured in the step S15 of the first oxidation step. Based on the elution amount, a second oxidizing agent is selected in the step S16. With the second oxidizing agent, the low-nickel film is oxidized to elute Chromium and thus to transform into an iron-concentrated film (S17 to S19). The iron-concentrated film is reduced with a reducing agent after the second oxidizing step including the steps of S13 to S19 to be dissolved and thus to be removed (S22).

### CROSS-REFERENCE TO RELATED APPLICATIONS

This application claims the benefit of priority of Japanese Patent Application No. 2017-054882, filed Mar. 21, 2017, the entire contents of which are incorporated herein by reference.

### BACKGROUND OF THE INVENTION

### Field of the Invention

The present embodiment relates to a decontamination technique of a radioactive-contaminated structure of a nickel-based alloy in a radiation handling facility.

### Description of the Related Art

In a radiation handling facility such as a nuclear power plant, radioactive nuclides accumulate on a surface of a structure operating under exposure to radiation such as equipment or piping, and its radioactivity increases with the passage of time.

Chemical decontamination of such a structure is conventionally applied in order to reduce an increase in exposure dose of workers during a replacement process of the structure, periodic inspection, or decommissioning processes. There is known a technique to remove a radionuclide together with an oxide film by repeating redox, the technique of which is in basis of a view of voltage dependency of an eluting reaction of the oxide film in which the radionuclide is accumulated.

There is also known a method of increasing processing capacity by gradually reducing an oxidation-reduction potential of decontamination solvent to a metal dissolution range and thereby dissolving both the oxide film and the metal base material.

Japanese Unexamined Patent Application Publication No. 2000-81498 and Japanese Translation of PCT International Application Publication No. 2002-513163 are related to these techniques.

### SUMMARY OF THE INVENTION

A method for decontaminating a nickel-based alloy includes the nickel-based alloy includes oxidization of an oxide film accumulating radioactive nuclides with a first oxidizing agent to elute nickel into a solvent and thus to transform into a low-nickel film (S13 to S15). Respective elution amounts of Nickel, Chromium, and Iron in the solvent are measured. On the basis of the elution amount, a second oxidizing agent is selected. With the second oxidizing agent, the low-nickel film is oxidized to elute Chromium and to transform into an iron-concentrated film. The iron-concentrated film is reduced with a reducing agent after the second oxidization process to be dissolved and thus to be removed.

### BRIEF DESCRIPTION OF THE DRAWINGS

In accompanying drawings,

FIG. 1 is a schematic cross-sectional view illustrating a steam generator as an example of a structure, to which a method for decontamination a nickel-based alloy according to an embodiment is applied;

FIG. 2 is a schematic cross-sectional view illustrating an oxide film and outer layer oxides on a surface of a steam generator thin tube;

FIG. 3 is a flowchart of the method for decontamination the nickel-based alloy according to the embodiment;

FIGS. 4A to 4D are diagrams illustrating the method for decontaminating the nickel-based alloy according to the embodiment;

FIG. 5 is a graph showing an elution ratio of each metal ion for each oxidizing agent;

FIG. 6 is a graph showing elution ratios of metal ions for each pH adjusting agent to be added when all the oxidizing agents to be used are ozone;

FIG. 7 is a triangular graph showing the transition of a content ratio of metal ions constituting the oxide film;

FIG. 8 is a graph showing the relationship between the immersion time of a test piece and the dissolution amount of iron of the test piece; and

FIG. 9 is a graph showing the relationship between the immersion time of a test piece and the dissolved amounts of Nickel and Chromium the test piece.

### DESCRIPTION OF THE EMBODIMENTS

Hereinafter, embodiments of the present invention will be described in detail with reference to the accompanying drawings.

As to decontamination of metal, it has been desired to enhance a decontamination effect on a structure in which there is a need for decontamination of a structure configured by using a specific nickel-based alloy such as a heat exchanger tube of steam generator used in a pressurized water nuclear power plant.

Part of oxide film surface of the nickel-based alloy becomes a sparingly-soluble spinel type oxide and erodes the inside of a base material; in addition to that a sparingly-soluble outer layer of oxide such as nickel ferrite is formed.

An object of the present embodiment is to provide a method for decontaminating a nickel-based alloy that can obtain a high effect in decontaminating the structure including the nickel-based alloy in a radiation handling facility.

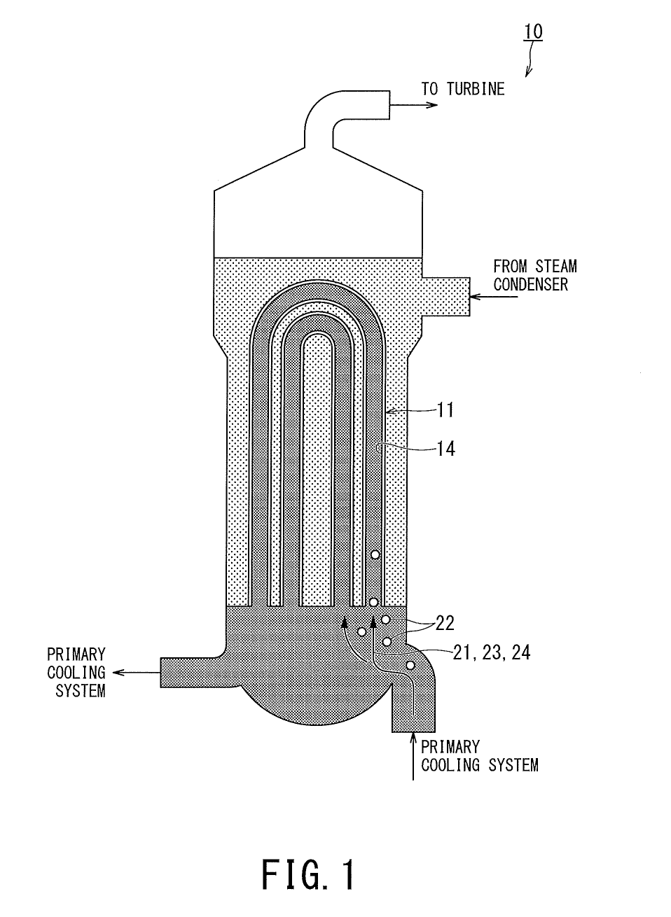

FIG. 1 is a schematic cross-sectional view illustrating a steam generator 10, to which a method for decontaminating a nickel-based alloy (hereinafter simply referred to as “decontamination method”) according to an embodiment is applied. In a pressurized water nuclear power plant (hereinafter simply referred to as “plant”), the heat of the high-temperature and high-pressure water heated in the reactor core is transferred to secondary cooling water in a heat exchanger tube (i.e., steam generator thin tube) 11 in the steam generator 10 to generate steam.

In plants in Japan, the heat exchanger tubes 11 are usually made of a nickel-based alloy like 600 alloy or 690 alloy of JIS standard. The heat exchanger tubes 11 made of a 600 alloy are used in rather old plants and have been gradually replaced with ones made of 690 alloy improved in corrosion resistance by increasing Chromium content.

Table 1 shows the composition of main alloying elements of 600 alloy and 690 alloy.

TABLE 1
%

| Composite (With JIS Specification) | Ni | Cr | Fe |
|---|---|---|---|
| Alloy 600 | 72 | 14~17 | 6~10 |
| Alloy 690 | about 60 | 30 | 9.5 |

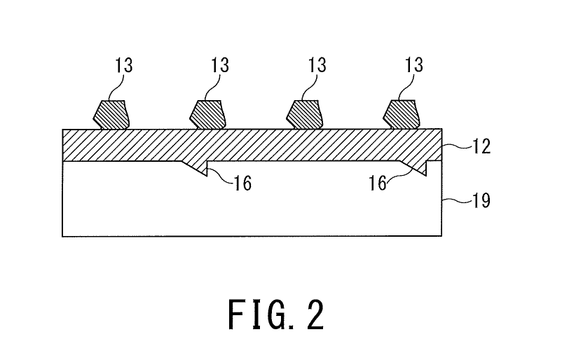

FIG. 2 is a schematic cross-sectional view of the oxide film 12 and the outer layer oxides 13 on the surface of the steam generator thin tube 11.

As shown in FIG. 2, the heat exchanger tube 11 made of one or plural types of alloy shown in Table 1 is exposed to strong reducing atmosphere in a primary system for a long time, which leads to formation of an oxide film 12 having high corrosion resistance on an inner surface 14 (FIG. 1) of the heat exchanger tube 11.

The heat exchanger tube 11, of which base material is the alloy shown in Table 1, is exposed to the primary system environment of strong reducing atmosphere for a long time, and an oxide film 12 having high corrosion resistances is formed on the inner surface 14 (FIG. 1) as shown in FIG. 2.

The oxide film 12 is a spinel type oxide of NiₓFe_{(1-X|t)}Cr_{(2-y)}O₄, composed of Nickel, Iron, and Chromium which are the composition of the base material.

The oxide film 12 contains internal oxide tentacles 16 that are mainly made of the grain boundaries and that penetrate sparsely into the base material.

On the surface layer of the oxide film 12, outer layer oxides 13 are formed. The outer layer oxides 13 are made of nickel oxides such as nickel oxide (NiO) or nickel ferrite (NiFe₂O₄), or iron oxides such as (Fe₃O₄).

Since both of the oxide film 12 and the outer layer oxides 13 are of low solubility, it is difficult to sufficiently remove both by the conventional decontamination method. The decontamination effect on the base material (structure made of the nickel-based alloy) 19 was therefore insufficient.

The decontamination method according to the embodiment is for removing the radionuclide accumulated on the surface of the sparingly soluble base material composed of such a specific nickel-based alloy by removing the oxide film 12 and the outer layer oxides 13.

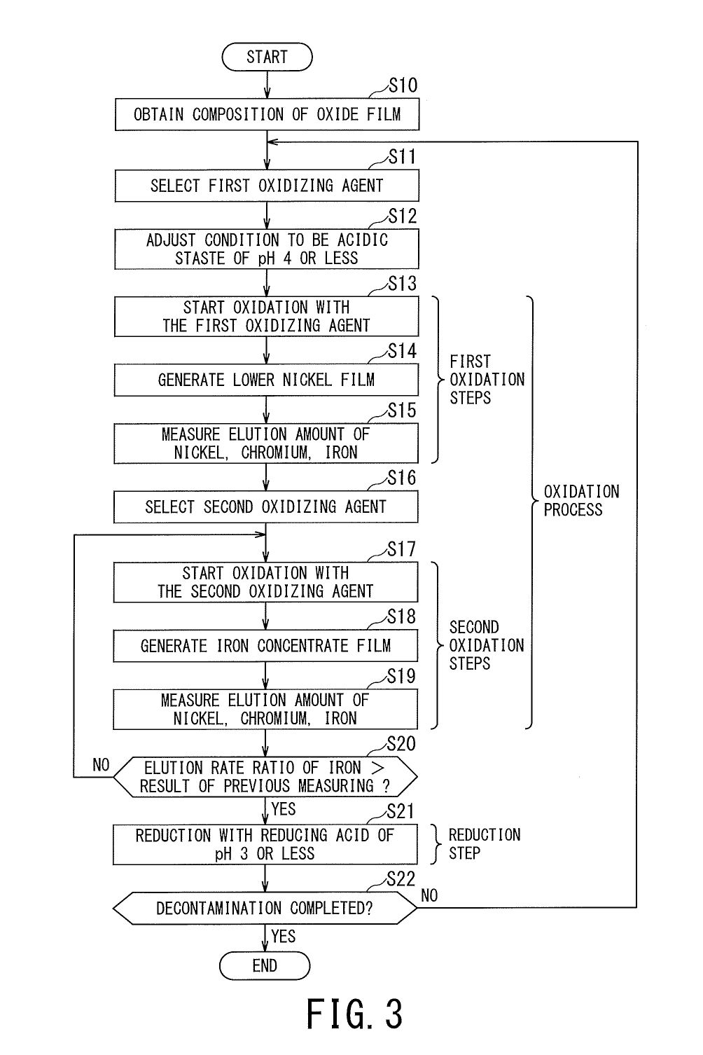

FIG. 3 is a flowchart of the decontamination method according to the embodiment.

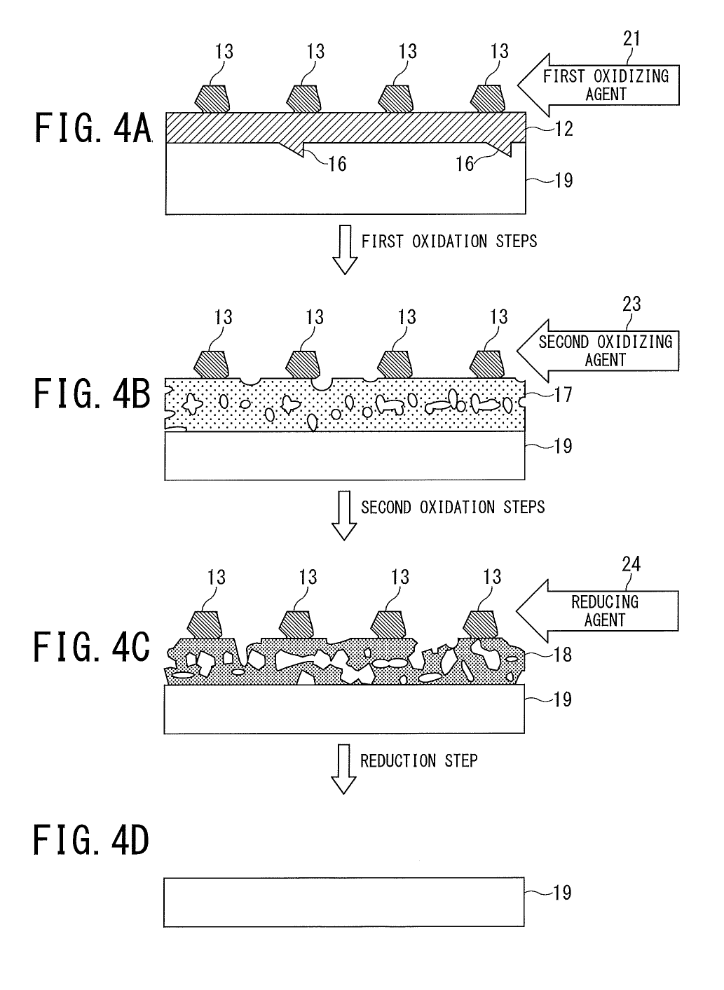

Each of FIGS. 4A to 4D is a diagram illustrating the method for decontaminating the nickel-based alloy according to the embodiment.

FIG. 4A illustrates the oxide film 12 and the outer layer oxides 13 before the decontamination. FIG. 4B illustrates the low-nickel film 17 and the outer layer oxides 13 formed in a first oxidation step including steps of S13 to S15 in FIG. 3. FIG. 4C illustrates the iron-concentrated film 18 and the outer layer oxides 13 formed in a second oxidation step including the steps of S17 to S19 in FIG. 3. FIG. 4D illustrates the base material 19 after a reduction step S21.

As shown in FIG. 3, the decontamination method according to the embodiment includes a composition obtaining step S10, a first oxidant selection step S11, a first oxidation step including the steps of S13 to S15 in FIG. 3, a second oxidant selection step S16, second oxidation step including the steps of S17 to S19 in FIG. 3, and a reduction step S21.

Hereinafter, the respective steps S10 to S22 of the decontamination method will be described according to the step number shown in FIG. 3 by referring to FIG. 1 and FIGS. 4A to 4D as required.

In the composition obtaining step S10, the composition of the oxide film 12 is obtained, in which the radionuclides are accumulated.

In addition to direct acquisition of part of the oxide film 12 for measurement, the composition may be estimated from, e.g., the model number of the heat exchanger tube 11, the age of use, or the quality of the primary cooling water.

What will be mainly obtained is the composition ratio of Nickel, Chromium, and Iron.

Hereinafter, ions of these main components, Nickel, Chromium, and Iron, of the nickel-based alloy are appropriately referred to as “metal ions”.

In the first oxidant selection step S11, a first oxidizing agent 21 is selected on the basis of the obtained composition.

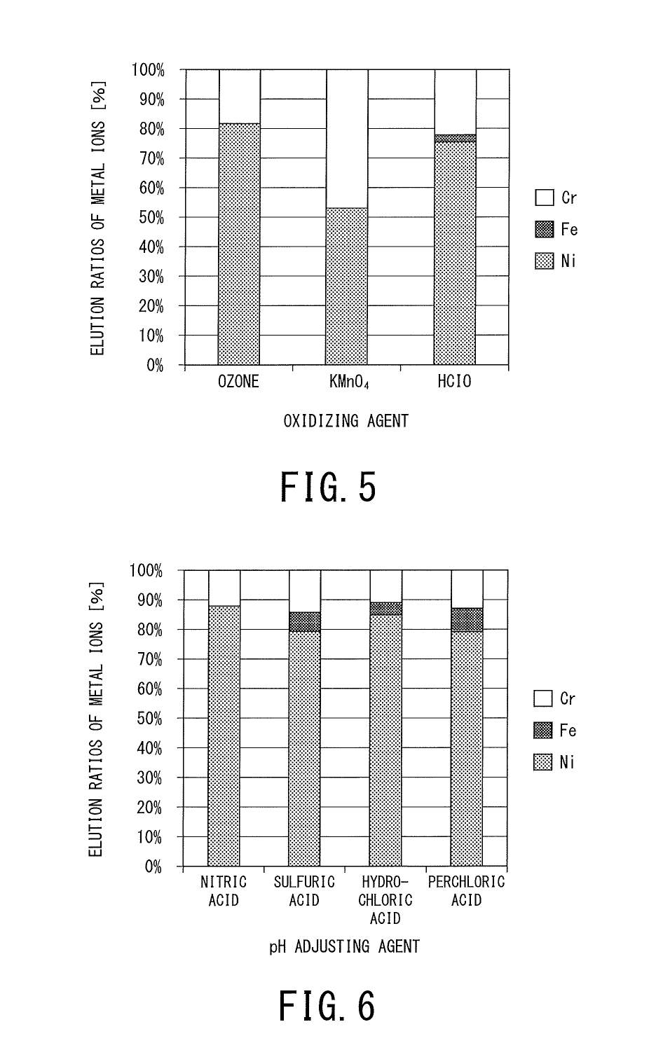

FIG. 5 is a graph showing the elution ratio of each metal ion for each oxidizing agent.

As shown in FIG. 5, the respective elution ratios of the metal ions are about 80° for Nickel and about 20° for Chromium, when all the oxidizing agents to be used are selected to be ozone.

Similarly, when potassium permanganate is used as an oxidizing agent, the respective elution ratios of the metal ions are about 50% for Nickel and for Chromium.

In addition, when perchloric acid is used as an oxidizing agent, Iron is also eluted by some %.

The first oxidizing agent 21 is selected based on the composition ratio obtained and these properties of each oxidizing agent such as ozone, potassium permanganate, and perchloric acid.

For instance, when the content ratio of iron ions in the base material 19 is high, perchloric acid as the first oxidizing agent 21 can efficiently elute Nickel.

Referring back to FIG. 3, the description of each step will be continued.

After the first oxidant selection step S11, solvent acidified by the pH adjusting agent 22 is flowed through the heat exchanger tube 11 to keep the inside thereof to be acidic condition of pH 4 or less at step S12. Under the acidic condition, oxidation process S13 to S19 is performed.

FIG. 6 is a graph showing elution ratios of metal ions for each pH adjusting agent 22 to be added, the oxidizing agent being unified to be ozone.

The pH adjusting agents 22 in FIG. 6 are nitric acid, sulfuric acid, hydrochloric acid, and perchloric acid.

As shown in FIG. 6, even when the same oxidizing agent is used, it is possible to control the elution ratio of eluted metal ions by adding a small amount of acid as the pH adjusting agent 22.

For instance, when it is desired to suppress elution of Iron, nitric acid having 0% dissolution rate for Iron may be added as the pH adjusting agent 22.

In the oxidation steps S13 to S19, it is desirable that the oxidation reduction potential (Oxidation-reduction Potential; ORP) is kept to be high oxidation atmosphere of 1000 mV or more.

The oxidation-reduction potential is adjusted with oxidizing agent such as ozone water, permanganate, hydrogen peroxide, perchloric acid.

In the first oxidation steps S13 to S15, the oxide film 12 is oxidized with the first oxidizing agent 21.

For instance, as shown in FIG. 5, since ozone selectively elutes Nickel, Nickel elutes from the oxide film 12 when the oxide film 12 is immersed in an ozone dissolved solvent for a long time.

Due to elution of nickel, the oxide film 12 transforms into a low-nickel film 17 having Chromium and Iron increased in ratio in the step S14 of the first oxidation step.

The transition from FIG. 4A to FIG. 4B shows the transition from the oxide film 12 to the low-nickel film 17.

In a predetermined time elapses from the timing at which the oxidation started in the step S13 of the first oxidation step, elution amounts of Nickel, Chromium, and Iron in the solvent are measured in the measuring step S15.

In the case of the decontamination of the steam generator 10 while being connected to the pressurized water reactor, the first oxidizing agent 21 and the pH adjusting agent 22 can be supplied, e.g., from a valve seat in a chemical volume control system; and so is measurement of the elution amount.

The chemical and volume control system (CVCS) is a line mainly for adjusting boron concentration in primary coolant.

On the basis of the elution amounts of the metal ions measured in the measuring step S15, the second oxidizing agent 23 is selected in the next second oxidant selection step S16. For instance, the small elution amount or the small elution ratio of Nickel means that the oxide film 12 has already transformed into the low-nickel film 17 in general.

At such an appropriate timing, the oxidizing agent is changed to another more appropriate oxidizing agent such as potassium permanganate as the second oxidizing agent 23.

Potassium permanganate is of high performance for eluting Chromium.

In the second oxidation steps S17 to S19, Chromium is eluted from the low-nickel film 17 with the second oxidizing agent 23.

With Chromium being eluted, the low-nickel film 17 transforms into an iron-concentrated film 18 having a higher iron ratio in the step S18.

The transition from FIG. 4B to FIG. 4C shows the transition of the oxide film 12 to the low-nickel film 17.

After a predetermined time elapses from the timing when the second oxidation started in the step S17, the dissolution speed ratio of Iron is measured in the measuring step S19.

The elution speed ratio is the elution speed of Iron as compared with Nickel and Chromium.

In the second oxidation process, the dissolution speed ratio of Iron and the measurement result of the previous dissolution speed ratio are compared. When this dissolution speed ratio is smaller than the previous measurement result, the second oxidation steps are continued (“YES” at determination step S20, returning to S17).

On the other hand, when the elution speed ratio becomes larger than the previous measurement result (“NO” at determination step S20), the oxidation process is terminated and the process proceeds to the reduction process of the step S21.

This is because an increase in the iron elution speed ratio can mean the formation of the iron-concentrated film 18.

When the low-nickel film 17 is thick, the iron-concentrated film 18 in the upper layer hinders the reaction between the second oxidizing agent 23 and the Chromium inside the film, which makes the alteration speed slow.

It is preferable to irradiate ultrasonic waves to the iron-concentrated film 18 gradually generated to remove the iron-concentrated film 18 in the upper layer portion as needed. The assistance by the irradiation is chosen in view of the fact that the iron-concentrated film 18 is fragile and easily peels off.

In the case of decontaminating the heat exchanger tube 11 with the heat exchanger tube 11 detached, the entire heat exchanger tube 11 may be vibrated to promote removal of the iron-concentrated film 18.

Further, in each of oxidation steps S13 to S19, the elution amount of metal ions in the solvent may be measured some times to change the type or proportion of the first oxidizing agent 21 or the second oxidizing agent 23.

That is, the oxidizing agent to be used may be changed twice or more in each of the oxidation steps (S13 to S19).

For instance, by measuring the amount of elution at some intervals, the composition ratio of the oxide film 12 may be different from the estimation and it may be found that the selected oxidizing agent is not optimal as the first oxidizing agent 21.

This is because the composition ratio of the oxide film 12 changes complicatedly depending on the operating condition of the plant, and therefore the solubility of the oxide film 12 in the oxidizing agent also varies from plant to plant.

In this case, by changing the first oxidizing agent 21 to the optimum oxidizing agent on the basis of the measured elution amount, it is possible to more efficiently degenerate the oxide film 12.

Further, on the basis of the measurement of the elution amount of the metal ions at some intervals, the elution ratio of metal ions can be also controlled by changing amounts of the pH adjusting agent 22, the first oxidizing agent 21, and the second oxidizing agent 23 as needed.

In the reduction step S21, the iron-concentrated film 18 is dissolved and removed with the reducing agent 24.

The transition from FIG. 4C to FIG. 4D represents the transition in which the iron-concentrated film 18 is removed together with the internal oxide tentacle 16 to become only the base material 19.

Although the reducing agent 24 is not particularly limited as long as it is a reducing acid, it is preferable to use an organic acid which is easily decomposed such as oxalic acid from the viewpoint of facilitating the final disposal of the decontamination solution.

In addition, by keeping the pH of the solvent at 3 or less, the iron-concentrated film 18 can be dissolved by immersion for a short time, and at the same time, the outer layer oxides 13 which are hardly soluble can be removed by peeling.

The reasons for turning Iron the last to elute are as follows: firstly, the dissolution speed of iron in the reduction step S21 is higher than that of Nickel and Chromium; secondly, Iron can be easily dissolved with many chemicals.

That is, once the iron-concentrated film 18 is formed in the oxidation steps S13 to S19, a high decontamination effect can be obtained in the reduction step S21 in a short time.

In the reduction step S21 as well as in the first oxidation step including the steps of S17 to S19, it is desirable to assist removal of the iron-concentrated film 18 with ultrasonic irradiation or vibration of the heat exchanger tube 11.

The above steps S11 to S21 are repeated till the oxide film 12 is sufficiently removed and decontamination is sufficient (corresponding to “NO” at the step S22).

When the heat exchanger tube 11 is sufficiently decontaminated (corresponding to “YES” at the step S22), all the processes of the decontamination method according to the embodiment are completed.

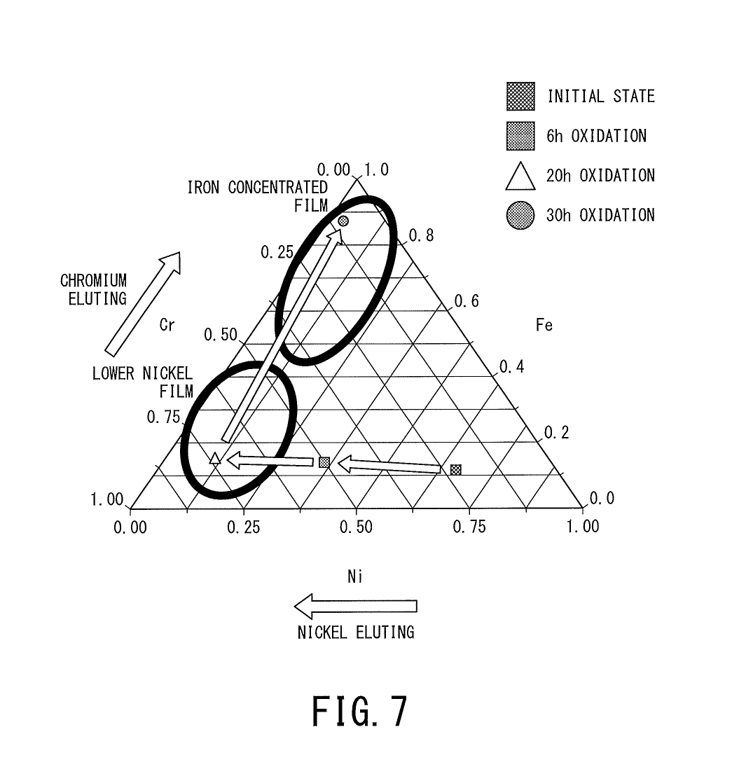

It is desirable to graph the above-described steps in a triangular graph showing the transition of the content ratio of metal ions constituting the oxide film 12 in FIG. 7.

By plotting the composition of each film on the triangular graph, optimum elution ratios of Nickel, Chromium, and Iron can be known, and so an optimum oxidizing agent can be selected.

In FIG. 7, the bottom axis of the triangular graph regulates the content ratio of Nickel, the left oblique axis thereof regulates the content ratio of Chromium, and the right oblique axis thereof regulates the content ratio of Iron.

In the case of FIG. 7, the first oxidizing agent 21 is selected on the basis of the ratio of Nickel:Chromium:Iron of 7:2:1 which is the ratio in the state before the first oxidation steps S13 to S15.

By the oxidation with the first oxidizing agent 21, the composition ratio of the oxide film 12 transits to the right hypotenuse side along the bottom axis of the triangular graph and becomes a low-nickel film 17 in about 20 hours.

In about 10 hours from the start of the oxidation with the second oxidizing agent 23, the composition-ratio point gradually moves upward and reaches the range of the iron-concentrated film 18.

### EXAMPLE

An example will be described with reference to Table 2 showing setting conditions of dissolution test.

TABLE 2
Oxidation Process

| Test Pieces | Alloy600 | |
|---|---|---|
| pH Adjusting Agent | Nitric Acid | |
| pH | 3 | |
| Temperature | 80° | C. |
| Oxidizing Agent | Ozone Gas | |
| Amount Of Oxidizing Agent | 3 | ppm |
| Redox Potential (ORP) | 1000 | mV |
| Immersion Time | 30 | h |

Reduction Process

| Reducing Agent | Oxalic Acid | |
|---|---|---|
| Redox Potential (ORP) | 2000 | mV |
| Temperature | 95° | C. |
| Immersion Time | 2 | h |

In the example shown in Table 2, a test piece of JIS standard 600 alloy was immersed in a solvent in which nitric acid was added as a pH adjusting agent.

In the oxidation step, the pH of the solution was kept at 3 and the temperature was kept at 80° C. As the first oxidizing agent, Ozone gas was used.

By keeping the ozone gas at 3 ppm, the oxidation-reduction potential of the solution was kept at 1000 mV. The test piece was immersed in such solution for 30 hours.

In 30 hours, the oxidation step was terminated and the reduction step was carried out.

In the reduction step, the test piece subjected to the oxidation step was immersed for 2 hours in a solution which has oxalic acid as a reducing agent, temperature of 95° C. and reducing agent amount of 2,000 ppm.

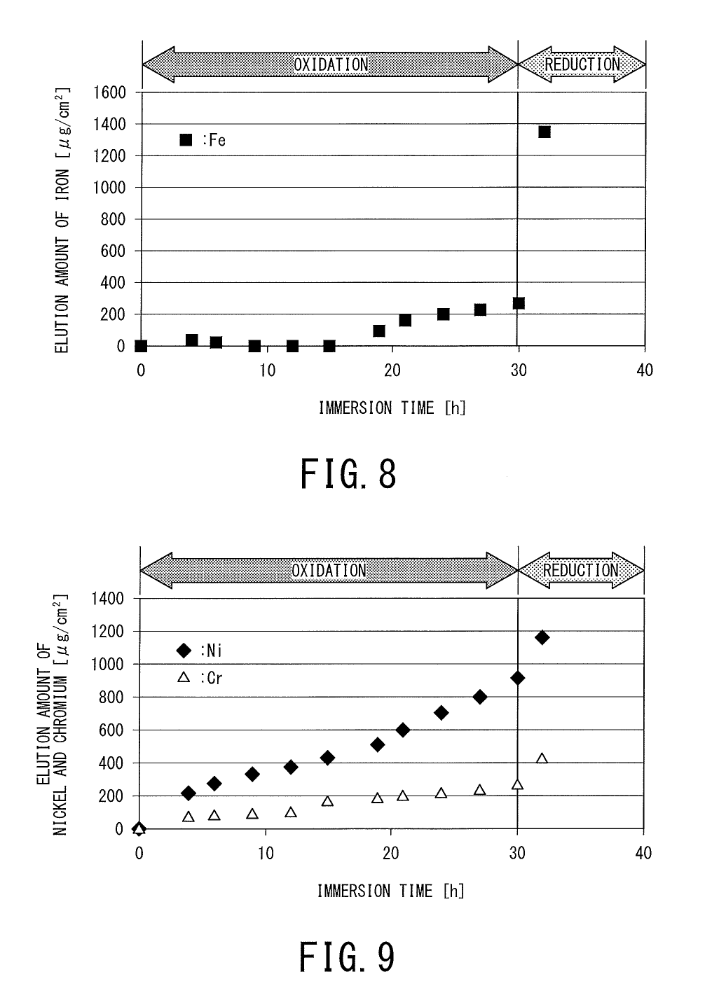

The results of this dissolution test are shown in FIG. 8 and FIG. 9.

FIG. 8 is a graph showing the relationship between the immersion time of a test piece and the dissolution amount of Iron of the test piece.

FIG. 9 is a graph showing the relationship between the immersion time of a test piece and the dissolved amounts of Nickel and Chromium of the test piece.

In FIG. 8, the dissolved amount of Iron significantly increased for 20 hours or more to 30 hours from the start of the oxidation step. This increase can be said to mean that an iron-concentrated film has been already formed.

Further, as shown in FIG. 8 and FIG. 9, Nickel, Chromium, and Iron were sufficiently dissolved in the reduction step even in a short time of 2 hours through the oxidation step according to the embodiment.

This dissolution experiment showed that the oxide film 12 on the specific nickel-based alloy such as 600 alloy of JIS standard can be efficiently removed by the decontamination method according to the embodiment.

As described above, according to the decontamination method of the embodiment, a high decontaminating effect can be obtained for the structure of the nickel-based alloy used in the radiation handling facility.

While several embodiments of the present invention have been described, these embodiments are only some aspects and are not intended to limit the scope of the invention. These embodiments can be implemented in various other forms, and various omissions, substitutions, changes, and combinations can be made without departing from the gist of the invention. These embodiments and modifications thereof are included in the scope and gist of the invention, as well as within the scope of the invention described in the claims and their equivalents.

For instance, the object to be decontaminated is not limited to the steam generator as long as it is structure in which 600 alloy or 690 alloy of JIS standard is included as composition and decontamination of radionuclide is required.

What is claimed is:

1. A method for decontaminating a nickel-based alloy, the method comprising:
first oxidizing a oxide film in which radionuclide is accumulated with a first oxidizing agent to elute Nickel into a solvent and to transform into a low-nickel film;
measuring elution amounts of Nickel, Chromium, and Iron in the solvent;
second selecting a second oxidizing agent based on the elution amount;
second oxidizing the low-nickel film with the second oxidizing agent to elute Chromium and thus to transform into an iron-concentrated film; and
dissolving and removing the iron-concentrated film by reducing the iron-concentrated film with a reducing agent after the second oxidizing step.

2. The method for decontaminating a nickel-based alloy according to claim 1, preceding the first oxidizing step, further comprising:
obtaining a composition of the oxide film, with the oxide film being formed on a surface of a structure made of the nickel-based alloy;
first selecting a first oxidizing agent based on the obtained composition.

3. The method for decontaminating a nickel-based alloy according to claim 1,
wherein the condition is adjusted to be an acidic state of pH 4 or less in at least one of the first and second oxidizing steps.

4. The method for decontaminating the nickel-based alloy according to claim 1,
wherein the condition is adjusted to be 1000 mV or more of an oxidation-reduction potential in at least one of the first oxidation step and second oxidation step.

5. The method for decontaminating the nickel-based alloy according to claim 4,
wherein the oxidation-reduction potential is kept in predetermined range by adding at least one of ozone water, permanganate, hydrogen peroxide, and per chloric acid.

6. The method for decontaminating the nickel-based alloy according to claim 1,
wherein the elution ratio of at least one of Nickel, Chromium, and Iron from at least one of the oxide film and the low-nickel film is controlled by adjusting a pH adjusting agent based on the composition of the oxide film in at least one of the first step and second oxidizing step.

7. The method for decontaminating the nickel-based alloy according to claim 1,
Wherein at least one of the first oxidizing step and the second oxidizing step includes:
measuring an elution speed ratio of at least one metal ion of Nickel, Chromium, and iron when the predetermined time passed; and
comparing an elution speed ratio of the metal ion with an elution speed ratio of the previous measurement result and proceeding to the reduction step when the elution speed ratio is larger than the ratio of the previous measurement result.

8. The method for decontaminating the nickel-based alloy according to claim 1,
wherein ultrasonic waves are irradiated to the iron-concentrated film to assist removal of the iron-concentrated film.

9. The method for decontaminating the nickel-based alloy according to claim 1,
wherein in the first oxidation step, the measuring step is executed and based on the measured elution amount, the first oxidizing agent is changed to another.

10. The method for decontaminating the nickel-based alloy according claim 1,
wherein in the second oxidation step, the measuring step is executed and based on the measured elution amount, the second oxidizing agent is changed to another.
